(19) United States
(12) Patent Application Publication
(10) Pub. No.: US 2015/0286286 A1
(43) Pub. Date: Oct. 8, 2015

(54) Foldable Keyboard

(71) Applicant: Shenzhen Hastech Industries Co., Ltd, Shenzhen City (CN)

(72) Inventors: Wei Jiang, Shenzhen City (CN); Yunfu Luo, Shenzhen City (CN); Shumeng Cai, Shenzhen City (CN); Tianxiang Zheng, Shenzhen City (CN)

(21) Appl. No.: 14/517,275

(22) Filed: Oct. 17, 2014

(30) Foreign Application Priority Data
Apr. 8, 2014 (CN) 201420167327.3

(51) Int. Cl. G06F 3/02; F16C 11/04

(52) U.S. Cl. CPC G06F 3/0221; F16C 11/04

(57) ABSTRACT

A foldable keyboard includes a rotation connecting part and keyboard modules hinged respectively to both sides of the rotation connecting part. The rotation connecting part includes a connecting base and turning plates hinged to both sides of the connecting base. The inner sides of the two keyboard modules are hinged to the connecting base concentrically. A sliding rod is arranged and protruded from each side edge of the two ends of the turning plates, and a corresponding sliding slot is arranged on each side edge of the two ends of the two keyboard modules respectively for the sliding rod to insert and slide therein. The two keyboard modules fold while rotate around a common axis on the connecting base when folding the foldable keyboard.

### FIELD OF THE INVENTION

The present invention relates to the field of keyboard technology, in particular relates to a foldable keyboard.

### BACKGROUND OF THE INVENTION

For touch control handheld electronic devices such as tablet computers and large screen cell phones, messages are mainly input by screen touch, usually without a physical keyboard. When a large number of word processing is necessary, a standard keyboard is usually required to be connected for users to input relatively quickly and strictly. However, carrying a bulky standard keyboard would bring much inconvenience to users. Therefore, numerous wireless foldable keyboards have appeared in the market, which employ Bluetooth as the communication manner to connect the keyboards to the touch control handheld electronic devices such as tablet computers. However, the existing wireless folding keyboard all have a connection structure of rotation in one side, thus the keyboard is easy to shake during opening and folding, and has a problem of inconvenient operation.

### SUMMARY OF THE INVENTION

The technical solution of the invention is to provide an easy-carrying and smoothly operated foldable keyboard.

The technical solution to the above-mentioned technical problem is: a foldable keyboard, including rotation connecting part and keyboard modules hinged respectively to the left side and the right side of the rotation connecting part; the rotation connecting part includes a connecting base and a turning plate hinged to the left side and the right side of the connecting base respectively; the inner sides of the two keyboard modules are hinged to the connecting base concentrically; a sliding rod is arranged and protruded from each side edge of the two ends of the turning plates, and a corresponding sliding slot is arranged on each side edge of the two ends of the two keyboard modules respectively for the sliding rod to insert and slide therein.

Furthermore, a plurality of first shaft sleeves are arranged, with spaces therebetween, on the left side and the right side of the connecting base, while a plurality of second shaft sleeves corresponding to the spaces between the first shaft sleeves are arranged, with spaces therebetween, on both sides of the turning plates. A core shaft is passed through a first shaft sleeve and the second shaft sleeve to hinge the turning plate to the connecting base.

Furthermore, soft rubber plugs are also included, which block the two ends of the core shafts to prevent the two ends from slipping out from the first shaft sleeve and the second shaft sleeve.

Furthermore, the soft rubber plugs are in a form of block, are arranged on both sides of the connecting base, and are above the bottom of the connecting base.

Furthermore, axis plates are arranged respectively near each inner side of the keyboard modules, each said axis plate having an axis hole protruding from the keyboard module; an hinging hole corresponding to the axis hole is arranged on said connecting base; a pin shaft is passed through the shaft hole and the hinging hole so as to hinge the axis plate to the connecting base; a snap spring is also arranged to lock the pin shaft and keep it from dropping out.

Furthermore, a plurality of positioning magnets are embedded inside the keyboard modules.

Advantageous effects: The two keyboard modules rotate around a common axis on the connecting base when folding the foldable keyboard. Because the sliding rod of the turning plate of the rotation connecting part is inserted and stuck in the sliding slot, when folding, the sliding of the sliding rod is limited in the sliding slot, which enables the smooth folding and opening between the keyboard module and the connecting base, improving operational comfort. Meanwhile, the turning plate is also hinged to the connecting base, and the turning plate is connected with the keyboard module through the action of the sliding rod and the sliding slot, that means, the keyboard module is hinged to the rotation connecting part through two rotation shafts. The connection of two rotation shafts makes the opening and folding of a keyboard more stable and smooth.

### BRIEF DESCRIPTION OF DRAWINGS

Further descriptions are made combined with the drawings attached according to the embodiments of the invention.

FIG. 1 is a schematic diagram of the embodiment of the invention.

FIG. 2 is a structural schematic diagram of the rotation connecting part according to the embodiment of the invention.

FIG. 3 is a partial schematic diagram of the invention in a folded state according to the embodiment of the invention.

FIG. 4 is the partial schematic diagram of the invention in an opened state according to the embodiment of the invention.

### DETAILED DESCRIPTION OF THE EMBODIMENTS

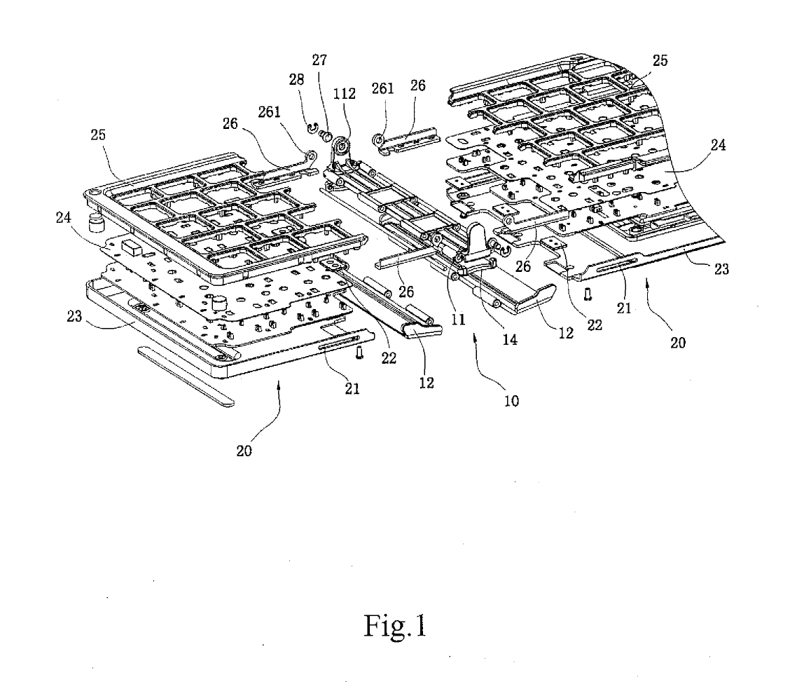

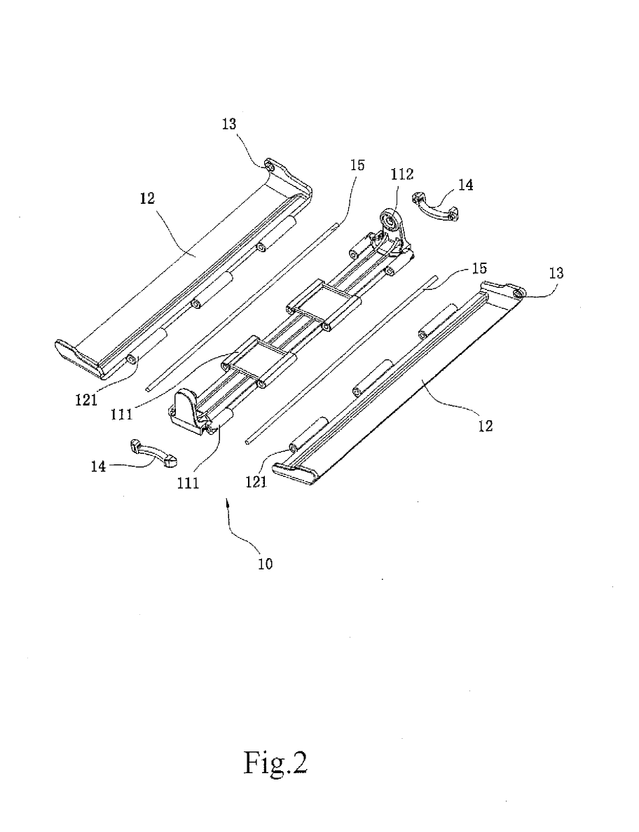

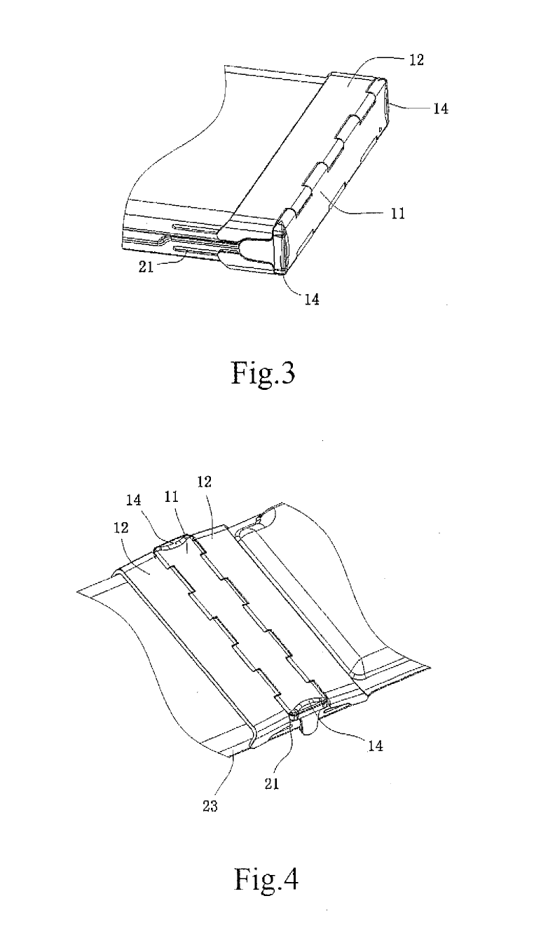

Referring to FIG. 1 to FIG. 4, a foldable keyboard according to the invention includes a rotation connecting part 10 and two keyboard module 20 hinged respectively to the two sides of the rotation connecting part 10. The rotation connecting part 10 includes a connecting base 11 and turning plates 12 hinged respectively to the left side and the right side of the connecting base 11. The inner sides of the two keyboard modules 20 are hinged to the connecting base 11 concentrically. A sliding rod 13 is arranged and protruded from each side edge of the two ends of the two turning plates 12. A corresponding sliding slot 21 is arranged on each side edge of the two ends of the two keyboard modules 20 respectively for the sliding rod 13 to insert and slide therein.

The two keyboard modules 20 fold while rotate around a common axis on the connecting base 11 when folding the foldable keyboard. As the sliding rod 13 of the turning plate 12 of the rotation connecting part 10 is embedded and stuck in the sliding slot 21 of the keyboard module 20, when folding, the sliding of the sliding rod 13 is limited in the sliding slot 21, which enables the smooth folding and opening between the keyboard module 20 and the connecting base 11, improving the operational comfort. Meanwhile, the turning plate 12 is also hinged to the connecting base 11, and the turning plate 12 is connected with the keyboard module through the action of the sliding rods 13 and sliding slot 21, that means, the keyboard module 20 is hinged to the rotation connecting part 10 through two rotation shafts. The connection of two rotation shafts makes the opening and folding of a keyboard more stable and smooth.

According to the embodiment, the rotation shaft 10 is composed of a connecting base 11 and two turning plates 12. The connecting base 11 is in a form of strip. A plurality of first shaft sleeves 111 are arranged, with space therebetween respectively, on both sides of the connecting base 11, while a plurality of second shaft sleeves 121 corresponding to the spaces between the first shaft sleeves 111 are also arranged, with spaces therebetween, on a side of the two turning plate 12. Namely, the space between two first shaft sleeves 111 is just suitable for holding the second shaft sleeve 121. After the alignment of each first shaft sleeve 111 with the second shaft sleeve 121, a core shaft 15 is passed through to hinge the turning plate 12 to the connecting base 11. In order to prevent the core shaft 15 from slipping out, on both ends of the connecting base 11, a soft rubber plug 14 is also arranged to block the core shaft 15. The soft rubber plug 14 is in a form of block and is a little above the bottom of the connecting base 11. When the keyboard is opened on the table, the soft rubber plugs 14 cling to the table surface, performing the functions of both support and skid prevention.

The keyboard module 20 is a combination of a bottom shell 23, a circuit board 24 and a face-piece 25, wherein a sliding slot is arranged on each side edge of the two ends of the bottom shell 23. On the bottom shell 23, a plurality of positioning magnets 22 are arranged. When folding the keyboard, the positioning magnets 22 within the two keyboard module 20 attracts each other under the force of magnetism, which makes the two keyboard modules more smooth when folding; meanwhile, prevents the two keyboard modules 20 from self-rotating and slipping-out.

Near the side edge of the two ends of the face-piece 25, an axis plate 26 is melted and welded respectively. Namely, each keyboard module 20 has two axis plates 26 arranged on both ends. Each axis plate 26 has an axis hole 261 at a position protruding from the keyboard module 20. On both ends of the connecting base 11, corresponding hinging hole 112 are arranged, the axis holes 261 on the correspondent axis plates 26 aligns with the corresponding hinging holes 112. A pin shaft is passed through the axis hole 261 and hinging hole 112, to enable the axis plate 26 to hinge to the connecting base 11. On the end of the pin shaft 27 a snap spring 28 is arranged, which jams the pin shaft 27 and prevents it from slipping out. The two keyboard modules on both the left side and the right side, through the action of the axis plate 26, hinge jointly to the connecting base 11 of the rotation connecting part 10.

Detailed explanations of the embodiments of the invention are made in combination of the drawings attached, but the invention is not limited to the above-mentioned embodiments. Ordinary technical personnel in said field of the invention, within the scope of their knowledge, may make various variations and displacements without departing the scope of the invention.

1. A foldable keyboard, including a rotation connecting part and a keyboard module hinged on both sides of the rotation connecting part, characterized in that: the rotation connecting part includes a connecting base and a turning plate hinged to both sides of the connecting base; the inner sides of the two keyboard modules are hinged to the connecting base concentrically; a sliding rod is arranged and protruded from each side edge of the two ends of the turning plates, and a corresponding sliding slot is arranged on each side edge of the two ends of the two keyboard modules respectively for the sliding rod to insert and slide therein.

2. The foldable keyboard according to claim 1, characterized in that: a plurality of first shaft sleeves is arranged, with spaces therebetween, on the two sides of the connecting base, while a plurality of second shaft sleeves corresponding to the spaces between the first shaft sleeves are arranged, with spaces therebetween, on both sides of the turning plates; a core shaft is passed through the first shaft sleeves and the second shaft sleeves to hinge the connecting base and the turning plate together.

3. The foldable keyboard according to claim 2, characterized in that: soft rubber plugs are also included, which blocks the two ends of the core shaft to prevent the two ends of the core shaft slipping out from the first shaft sleeves and the second shaft sleeves.

4. The foldable keyboard according to claim 3, characterized in that: the soft rubber plugs are in a form of block, are arranged on both ends of the connecting base and are above the bottom of the connecting base.

5. The foldable keyboard according to claim 1, characterized in that: axis plates are arranged respectively near each inner side of the keyboard modules, each said axis plate having an axis hole protruding from the keyboard module; an hinging hole corresponding to the axis hole is arranged on said connecting base; a pin shaft is passed through the shaft hole and the hinging hole so as to hinge the axis plate to the connecting base; a snap spring is also arranged to lock the pin shaft and keep it from dropping out.

6. The foldable keyboard according to claim 1, characterized in that: a plurality of positioning magnets are embedded inside the keyboard module.
